(19) United States
(12) Patent Application Publication
(10) Pub. No.: US 2015/0162042 A1
(43) Pub. Date: Jun. 11, 2015

(54) PERPENDICULAR MAGNETIC RECORDING MEDIUM AND METHOD OF MANUFACTURING THE SAME

(71) Applicant: KABUSHIKI KAISHA TOSHIBA, Minato-ku (JP)

(72) Inventors: Kaori Kimura, Yokohama (JP); Soichi Oikawa, Hachioji (JP); Kazutaka Takizawa, Kawasaki (JP); Akira Fujimoto, Kawasaki (JP); Akihiko Takeo, Kokubunji (JP)

(73) Assignee: KABUSHIKI KAISHA TOSHIBA, Minato-ku (JP)

(21) Appl. No.: 14/496,648

(22) Filed: Sep. 25, 2014

Related U.S. Application Data
(63) Continuation-in-part of application No. 14/197,674, filed on Mar. 5, 2014.

(30) Foreign Application Priority Data
Dec. 6, 2013 (JP) 2013-253428
Jul. 22, 2014 (JP) 2014-148787

(51) Int. Cl. G11B 5/66; G11B 5/851; G11B 5/84; G11B 5/64; G11B 5/65

(52) U.S. Cl. CPC G11B 5/66; G11B 5/645; G11B 5/656; G11B 5/8404; G11B 5/851

(57) ABSTRACT

According to one embodiment, a perpendicular magnetic recording medium includes a substrate, an underlayer formed on the substrate and a magnetic recording layer formed on the underlayer and having an easy axis in a direction perpendicular to a film surface. The underlayer includes a plurality of projecting portions arranged at a distance of 1 nm to 20 nm from one another. The magnetic recording layer is an amorphous magnetic recording layer including a plurality of magnetic grains each formed to expand towards a top end thereof from a surface of a respective projecting portion of the underlayer, at least those of the magnetic grains located on a respective projecting portion side being separated from each other.

### CROSS-REFERENCE TO RELATED APPLICATIONS

This application is a Continuation-in-Part application of U.S. patent application Ser. No. 14/197,674, filed Mar. 5, 2014 and based upon and claiming the benefit of priority from Japanese Patent Applications No. 2013-253428, filed Dec. 6, 2013; and No. 2014-148787, filed Jul. 22, 2014, the entire contents of all of which are incorporated herein by reference.

### FIELD

Embodiments described herein relate generally to perpendicular magnetic recording media and methods of manufacturing such perpendicular magnetic recording media.

### BACKGROUND

It is essential for current perpendicular magnetic recording media to establish the perpendicular orientation of the recording layer and isolation of magnetic grains to be compatible with each other. In the conventional techniques, the granular structure, in which perpendicularly orientated ferromagnetic grains (of CoPt-, FePt-, CoPd-alloys, etc.) are arranged in a matrix of an oxide (SiOₓ, TiOₓ, AlOₓ or the like). However, the conventional techniques entail the problem of dispersion in grain diameter among magnetic grains, which is caused by the reduction of the number of grains per 1 bit as the density is increased. The dispersion in grain diameter is mainly caused due to the projections and recesses on the underlayer and the crystal grain sizes. Here, various attempts have been performed, yet it has not been possible to suppress the dispersion to date. One reason for this is that the granular structure and crystalline anisotropy can only be satisfied at the same time with specific materials such as Ru and MgO, and another reason is that in the recording layer, being crystalline itself, unique grain growth of its own occurs. By contrast, amorphous magnetic recording layers can be perpendicularly oriented regardless of their underlayers, and they do not exhibit their own grain growths, thereby making it easy to trace the shapes of the underlayers. Thus, when an amorphous material is employed for the magnetic recording layer, it is expected to be able to form a structure with a less grain diameter dispersion regardless of the material used for the underlayer.

For example, when TbFeCo is selected as the amorphous material, such a magnetic recording medium which has the structure of pinning magnetic domain walls of TbFeCo of the recording layer can be manufactured by employing a material having a fine projection-and-recess structure, such as Al or TiN, for the underlayer.

In addition, other types of magnetic recording media are conventionally available, that is, for example, one is that a matrix comprising a carbon cluster is subjected to plasma etching to form projections and recesses (of 5 nm to 3 nm), and an amorphous recording layer is formed on top thereof, thereby manufacturing a magnetic recording medium in which the magnetic domain walls are pinned by the projections and recesses of the underlayer. Another is that a TbFeCo amorphous recording layer is formed on an FePt granular layer, thus manufacturing a magnetic recording medium in which the shifting of the magnetic domain walls of the amorphous recording layer is suppressed by the granular layer.

However, in general, it has been conventionally difficult with such fine projections and recesses and such a granular layer to fix a magnetic domain when a high-density recording is carried out, and therefore it is conventionally recognized to be difficult to apply the technique to the magnetic recording media.

### BRIEF DESCRIPTION OF THE DRAWINGS

FIG. 1 is a schematic cross sectional view showing a structure of a perpendicular magnetic recording medium according to an embodiment;

FIG. 2 is a schematic view showing a pattern of arrangement of projections of an underlayer as viewed from above;

FIG. 3 is a schematic view showing another pattern of arrangement of projections of an underlayer as viewed from above;

FIG. 4 is a schematic view showing still another pattern of arrangement of projections of an underlayer as viewed from above;

FIG. 5 is a cross sectional view showing an example of the shape of projections of an underlayer;

FIG. 6 is a cross sectional view showing another example of the shape of projections of an underlayer;

FIG. 7 is a cross sectional view showing still another example of the shape of projections of an underlayer;

FIG. 8 is a cross sectional view showing still another example of the shape of projections of an underlayer;

FIGS. 9A, 9B, 9C, 9D and 9E are views showing an example of a manufacturing method of a perpendicular magnetic recording medium according to an embodiment;

FIG. 10 is a graph showing a magnetization curve of a perpendicular magnetic recording medium according to an embodiment;

FIGS. 11A, 11B, 11C and 11D are views showing another example of a manufacturing method of a perpendicular magnetic recording medium according to an embodiment; and

FIGS. 12A, 12B, 12C, 12D, 12E and 12F are views showing still another example of a manufacturing method of a perpendicular magnetic recording medium according to an embodiment.

### DETAILED DESCRIPTION

According to the first embodiment, a perpendicular magnetic recording medium comprises a substrate, an underlayer formed on the substrate, and a magnetic recording layer formed on the underlayer and having an easy axis in a direction perpendicular to a film surface.

The underlayer comprises a plurality of projecting portions arranged at distances of 1 nm to 20 nm.

The magnetic recording layer is an amorphous magnetic recording layer comprising a plurality of magnetic grains each formed to expand towards its distal end from the surface of each projecting portion of the underlayer, in which at least those of the magnetic grains which are located on the projecting portion side are separated from each other.

According to the embodiment, a magnetic recording medium can be obtained, which has such a structure in which projecting portions arranged at a certain distance are formed on a substrate, and an amorphous recording layer is deposited thereon. The amorphous recording layer forms a columnar structure to fit each projection portion, and is deposited to have such a shape to expand towards its distal end from the surface of the projecting portion. Further, on the outermost part, the amorphous recording layer may be continuously formed as a whole. A magnetic recording medium having such a structure takes a simultaneous rotary magnetization reversal mode as of the granular structure, not a domain wall motion type magnetization reversal mode as of an ordinary amorphous recording layer. Since the domain walls are stabilized as they are pinned with a gap, the magnetic recording medium of this type can be used for high-density recordings.

According to the second embodiment, there is provided a method of manufacturing a perpendicular magnetic recording medium. This method is an example of the process of manufacturing a perpendicular magnetic recording medium according to the first embodiment, and it comprises: forming an underlayer to be processed, on a substrate; applying a dispersion of fine particles on the underlayer to be processed, thereby forming a single-layer of the fine particles; etching the underlayer via the fine particles, thereby forming an underlayer comprising projecting portions; and depositing an amorphous magnetic recording layer on surfaces of the projecting portions.

According to the third embodiment, there is provided a method of manufacturing a perpendicular magnetic recording medium. This method is another example of the process of manufacturing a perpendicular magnetic recording medium according to the first embodiment, and it comprises: forming an underlayer to be processed, on a substrate, using a metallic compound having an eutectic crystal structure comprising grains and a grain boundary; etching the underlayer such that grains of the eutectic crystal structure remain, thereby forming an underlayer comprising projecting portions; and depositing an amorphous magnetic recording layer on surfaces of the projecting portions.

According to a magnetic recording medium of another embodiment, an anti-oxidation layer may be provided between an underlayer comprising projecting portions and an amorphous recording layer in a magnetic recording medium of the first embodiment.

Further, according to a method of manufacturing a magnetic recording medium of still another embodiment, forming an anti-oxidation layer may be executed before the deposition of an amorphous recording layer in the method of manufacturing a magnetic recording medium according to the second or third embodiment.

Use of the amorphous material is advantageous in that projections and recesses can be easily traced during sputtering. However, many amorphous magnetic materials contain rare earth, and therefore they tend to be oxidized. For example, if an amorphous magnetic material such as of TbFeCo is stacked on an SiO₂ underlayer comprising projecting portions, Tb easily oxidizes by taking oxygen atoms from SiO₂, and therefore the magnetostatic properties change in some cases. This drawback can be prevented by replacing SiO₂ with a non-oxide such as SiNₓ.

If the underlayer comprising projecting portions has an oxide or hydroxyl group in the processing step, there may result such a drawback that a similar change in magnetic properties occurs. In this case also, an anti-oxidation layer may be sandwiched between the underlayer comprising projecting portions and the amorphous magnetic recording layer. Various materials can be used for the anti-oxidation layer, but when, for example, crystalline Pd is used, crystal grains tend to be produced, making it difficult to trace the shape of the projections and recesses of the underlayer on the recording layer. Therefore, an amorphous material may be used as the anti-oxidation layer. When an amorphous material similar to that of the magnetic recording layer is used for the anti-oxidation layer as well, it is possible to trace the configuration of the underlayer while preventing oxidation. A medium which comprises such an anti-oxidation layer and such a magnetic recording layer has a low dispersion in grain size, thereby making it possible to reduce the jitter noise, and at the same time to have a good environmental stability.

<Material for Amorphous Recording Layer>

The amorphous magnetic recording layer can be formed of an alloy of an amorphous rare earth element and a transition metal (R-TM), and an additive element.

As the amorphous rare earth element, one of Nd, Sm, Gd, Tb and Dy can be used.

As the transition metal, Fe, Co, Ni, or the like can be used.

The layer can contain, as the additive element, Pt, Au, Ag, In, Cr, Ti, Si or Al.

Specific examples of the alloy are Gd—Co, Gd—Fe, Tb—Fe, Gd—Tb—Fe, Tb—Co, Tb—Fe—Co, Nd—Dy—Fe—Co and Sm—Co.

When the rare earth element is of a light type (such as Nd), it has a magnetization parallel to that of the transition metal, and therefore a ferromagnetic body is obtained. When the rare earth element is of a heavy type (such as Gd, Tb or Dy), it has a magnetization of an opposite direction to that of the transition metal, and therefore a ferrimagnetic body is obtained. When the ferrimagnetic body is used, the saturation magnetization Ms becomes lower, and therefore the coercive force Hc can be raised. In the meantime, as the transition metal, Fe, Co or Ni may be used, but when Ni is used, the Curie temperature Tc tends to be equal to or lower than room temperature.

When an easily oxidizable material such as Cr, Si, Ti, Al or In is mixed in small amount into the alloy, the oxidization of the magnetic material can be suppressed. When a small amount of a noble metal such as Au, Pt or Ag is mixed therein, the oxidization suppressing effect can be obtained as well. The above-listed additive element can be mixed up to a ratio of 30 at % or 10 at % with respect to a total amount of the composition. An excessive amount of the additive element tends to cause a lowering in saturation magnetization Ms or perpendicular magnetic anisotropy Ku.

In the embodiment, TbCo alloys can be used.

Of the TbCo alloys, Fe, which oxidizes relatively easily, is not used, and therefore such a TbCoCr alloy that the content of Tb is less than its compensation ratio in composition and the composition ratio of the transition metal is increased can be used.

The amorphous recording layer may be deposited to have a thickness of 3 nm to 30 nm. When the thickness is less than 3 nm, an effective perpendicular magnetization film tends not to be obtained due to an adverse effect of an initial layer, and the magnetic recording volume tends to be insufficient. On the other hand, when exceeding 30 nm, the head magnetic field necessary for magnetization reversal tends to be short.

<Shape of Amorphous Recording Layer>

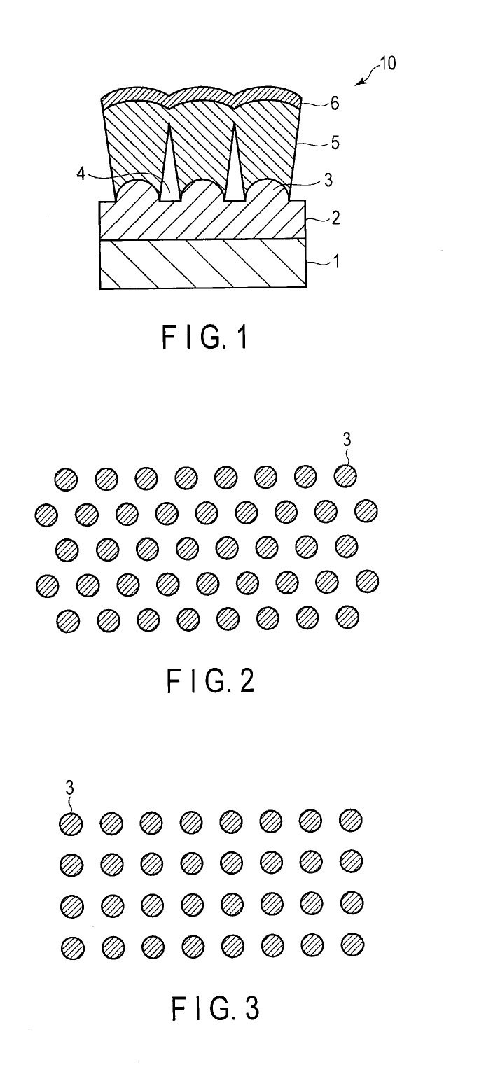

FIG. 1 shows a schematic cross sectional view of a structure of a perpendicular magnetic recording medium according to the embodiment.

An amorphous recording layer 5 is deposited on an underlayer 2 formed on a substrate 1, and it has such a columnar structure as shown in FIG. 1. At an initial stage, the recording layer 5 is deposited in such a manner that portions thereof are separated from each other by projecting portions 3 of the underlayer 2. As the thickness of the film increases, the size of magnetic grains increases to narrow the regions of gaps 4, and eventually, adjacent magnetic grains tend to bond to each other. The magnetic grains may bond to each other in the region of an uppermost layer, or may grow in a columnar manner without bonding to each other. However, in such a case where only a lowermost portion of 2 nm of the entire layer of 20 nm is separated and the rest of the portion is uniformly amorphous, the effect of the embodiment may be hard to obtain. Therefore, the separated region may be set at least ⅓ of the entire thickness. The state of the separation can be observed by such a method as cross sectional TEM (Transmission Electron Microscope). In addition to shape of projecting portions of the underlayer, a high gas pressure when the amorphous recording layer is formed, can accelerate growth of the magnetic grains in a columnar manner. When the amorphous recording layer is formed by sputtering process under Ar atmosphere, if not less than 0.5 Pa of the gas pressure can be used, the separated region can be set at least ⅓ of the entire thickness. Further the gas pressure can be between 0.5-20 Pa.

For example, when TbCoCr is grown on the underlayer, the structure of the underlayer can be retained up to a portion of a thickness of about 30 nm. But, when thicker than that, the underlayer may take a columnar structure consisting of grains bonding to each other. For this reason, the recording layer may be formed to have a thickness of 30 nm or less.

It should be noted here that a magnetic layer in such a state that all or part thereof is isolated on the underlayer 2 as in the case of the amorphous recording layer 5 of the embodiment shown in FIG. 1 may be expressed as “magnetic grains”. The term “magnetic grains” may be used to refer to the grain portion of the granular structure as well. The magnetic grains are different from the fine particles used in the template.

<Magnetic Properties of the Amorphous Recording Layer>

The magnetic recording medium of the embodiment can exhibit magnetization rotary magnetic properties. The magnetic properties can be measured with a vibration sample magnetometer (VSM) or a Kerr effect measuring instrument.

The coercive force Hc of the perpendicular magnetic recording layer can be set to 2 kOe or higher. When the coercive force Hc is less than 2 kOe, a high surface recording density tends to be difficult to obtain.

The perpendicular squareness of the magnetic recording layer can be set to 0.9 or higher. The perpendicular squareness referred to here is a result of dividing the remanent magnetization Mr by the saturation magnetization Ms. When the perpendicular squareness is less than 0.9, the crystal orientation may have been deteriorated or such a structure that the thermal stability is partially decreased, may have been formed.

In the meantime, let us define that the magnetic field at the point of intersection of a tangential line to the magnetization curve near Hc and a negative saturation value is a nucleation magnetic field Hn. Here, Hn is smaller than Hc, but Hn can be set as large as possible from the view points of, for example, reproduction output, resistance to thermal decay and resistance to data erase while recording on adjacent tracks. At the same time, however, when Hn is increased, the slope α of the magnetization curve in the vicinity of Hc is increased accordingly; therefore the S/N ratio tends to decrease.

In general, the slope α of the magnetization curve in the vicinity of Hc is expressed as the following equation (1):

α=4πdM/dH|H=Hc (1),

where M represents a magnetization and H represents an external magnetic field. With granular-type the perpendicular magnetic recording media currently in the actual use, a is around 2. This is because comprehensively, good recording reproduction properties can be achieved by strengthen the bonding between grains to some degree. However, basically, a high S/N ratio at a high liner recording density tends to be obtainable when the bonding between grains is weak. Even for the granular-type the perpendicular magnetic recording media, the bonding between grains tends to be excessively strong when a is larger than 3. If a becomes 5 or more, such a tendency is enhanced that magnetic grains do no longer exhibit magnetization reversal in a manner of being independent of one another, but they reverse as pulled by the reversal of adjacent grains.

<Anti-Oxidation Layer>

An anti-oxidation layer may be further added between the underlayer with projecting and recessed portions and the amorphous recording layer. The anti-oxidation layer serves to prevent contamination on the surface of the underlayer, created during processing the projecting and recessed portions thereof, from migrating to the highly reactive amorphous recording layer. Examples of the surface contaminants are oxygen, oxides, hydroxides, or in some rare cases, nitrides, chlorides and fluorides. It is therefore preferable that a material which is not reactive by itself with the recording layer be employed. Specific examples of such a material are noble metals such as Pd, Ru, Pt, Au, Cu and Ag, and transition metals such as Ti, Cr, Fe, Co, Ni, Ta and W. Further, for a high traceability of the shape, the material of the anti-oxidation layer should preferably not have crystal grains. The materials listed above do not have such large crystal grains when deposited in a thickness of the order of several nanometers, but some of them may have crystal grains having a diameter of 5 to 6 nm already when deposited in a thickness of about 10 nm. Here, since the crystal grains of the film and the shape of the projections and recesses of the underlayer do not exhibit one-to-one correspondence, the amorphous recording layer tends to grow along the crystal grains of the anti-oxidation layer. In order to solve this problem, an amorphous material should preferably be selected when a thick anti-oxidation layer is provided. Typical examples of the amorphous material are Ni—Ta, Cr—Ti and Zr—Fe. An amorphous film can be obtained by sputtering a combination of at least one type selected from a first metal group consisting of Ti, Ta, Hf, Nb and Zr and at least one type selected from a second metal group consisting of Cr, Fe, Co, Ni, Cu, Mo, Rh, Pd and Ir. The contrast to the shape of the projections and recesses of the underlayer can be confirmed by planer/cross-sectional observation using a scanning electron microscope (SEM) or TEM.

It is preferable that the amorphous material should not have magnetic properties. If the amorphous material is magnetic, the magnetic properties thereof tend to vary due to oxidation, and eventually the magnetic properties of the recording layer continuously growing will be affected.

The anti-oxidation layer should preferably be thick in view of the prevention of oxidation. For example, when the anti-oxidation layer has a thickness of less than 1 nm, the film is not continuously deposited. As a result, the anti-oxidation effect tends to be reduced. On the other hand, if excessively thick, the shape of the projections and recesses tends to be flattened. For example, when the anti-oxidation layer has a thickness of more than 30 nm, the film is continuously deposited. Therefore, the amorphous recording layer film will have domain wall motion-type magnetic properties. For the reasons stated above, it is preferable that the anti-oxidation layer have a thickness in the range of 1 nm to 30 nm.

<Shape of Underlayer>

FIGS. 2 to 4 each schematically show an arrangement pattern of projecting portions of the underlayer as viewed from above.

The arrangement pattern of the projecting portions 3 of the underlayer may be regular. For example, the arrangement of the projecting portions 3 of the underlayer as viewed from above may have a circular (or polygonal) pattern of a close-packed arrangement at a pitch of 4 to 20 nm as shown in FIG. 2, or a square pattern of an arrangement at a similar pitch as shown in FIG. 3.

When the arrangement pitch is wider than 20 nm, the recording density of the magnetic recording medium tends to lower. On the other hand, when less than 4 nm, the recording tends to be erased due to the adverse effect of thermal decay.

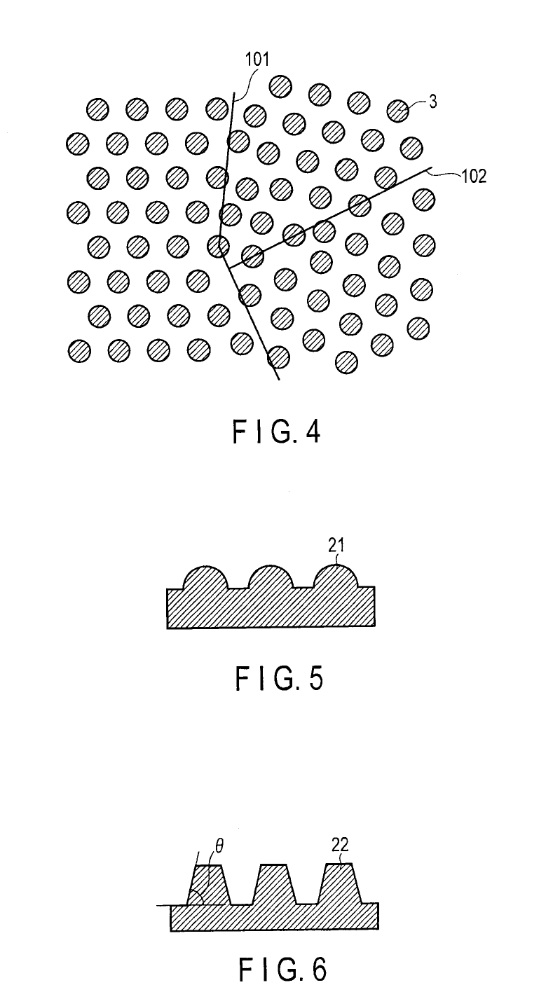

It should be noted that the pitch of the projecting portions in the arrangement patterns is expressed by the distance between the centers of adjacent projecting portions. These patterns may have a domain of several hundred nanometers or more as in, for example, a region enclosed by boarder lines 101 and 102 shown in FIG. 4, that is, an aggregate of regularly arranged patterns. Here, the arrangements themselves may not necessarily be completely close-packed.

The depth of the grooves formed in the arrangement of the projecting portions can be set to 3 nm to 30 nm. When the depth of the groove is less than 3 nm, atoms may be embedded in even the groove portion during sputtering, thereby hindering the isolation of grown magnetic grains from one another. When the depth exceeds 30 nm, the distance to a soft magnetic under layer becomes excessive, which tends to cause the lowering of the recording density.

Further, the underlayer comprises a plurality of projecting portions arranged at an interval of 1 nm to 20 nm. This means that the distance between the grooves of adjacent projecting portions is 1 nm to 20 nm.

When the distance between the grooves of adjacent projecting portions is less than 1 nm, the magnetic film deposited is supported on right and left side without being separated by the groove, and thus the film tends to be formed continuously. For this reason, with a pattern including grooves having a depth of less than 3 nm and a width of less than 1 nm, the film tends to have substantially the same configuration as that of the flat substrate.

FIGS. 5 to 8 each show an example of a cross section of the shape of projecting portions of the underlayer.

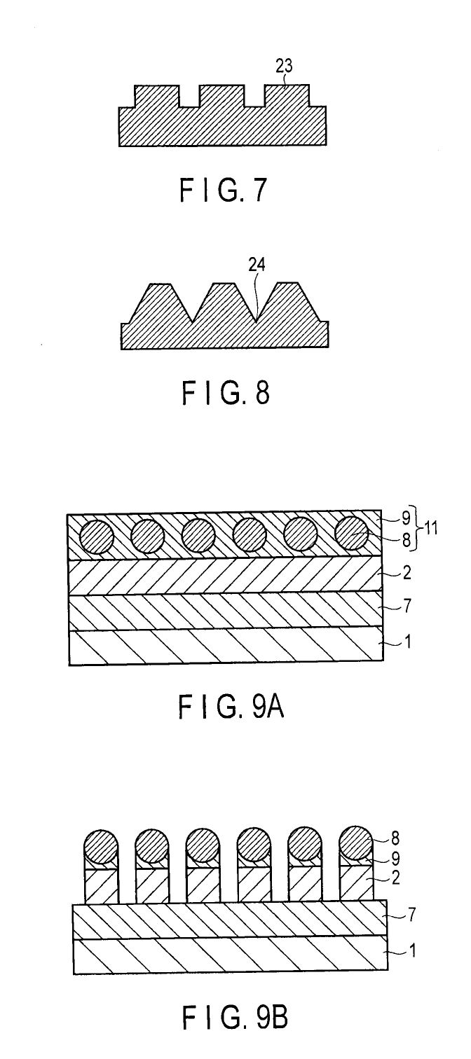

As the shape of the projections and recesses, there are, for example, a semicircular shape 21 such as shown in FIG. 5, a trapezoidal shape 22 such as shown in FIG. 6, a cylindrical shape 23 such as shown in FIG. 7 and a V-shaped groove 24 such as shown in FIG. 8. Note that in the case of a trapezoidal shape, the angle θ of a side of the trapezoid with respect to the direction parallel to the bottom of the groove of the underlayer, that is, the so-called taper angle, is less than 30 degrees, the orientation tends to be perpendicular to the side surface, thereby making it not possible to obtain a perpendicular magnetic film with respect to the substrate.

<Material for Underlayer>

For the underlayer, various materials can be used in consideration of corrosiveness and endurance.

Examples of the material used for the underlayer are inorganic materials such as C and Si, metals such as Al, Ti, Cr, Mn, Fe, Co, Ni, Cu, Zn, Ge, Zr, Nb, Mo, Ru, Rh, Pd, Ag, In, Hf, Ta, W, Ir, Pt and Au, alloys thereof (such as CrTi and NiW), oxides thereof, nitrides thereof, etc. In particular, when a material of C, Al, Ta, Fe, Pt or Au is used, the formation of projections and recesses tends to become easy and the affinity to the amorphous material tends to be better.

A buffer layer may be interposed between the underlayer and the amorphous magnetic material. In the case where an amorphous recording layer of TbFeCo is deposited directly on a material of, for example, Ag, Ag diffuses to disable the perpendicular magnetization in some cases. By contrast, with a buffer layer, the reaction between the underlayer and the amorphous magnetic layer can be suppressed. Alternatively, in the case where an amorphous recording layer of TbFeCo is deposited directly on a material of Au, processed by RIE using CF₄ gas, the surface of the Au underlayer is contaminated with fluorine, which induces a similar reaction to occur. Here, it may be possible to solve this drawback by depositing the amorphous magnetic layer to be thick; however when the distance to the soft magnetic under layer increases excessively, it tends to cause the lowering of the recording density.

In such a case, a buffer layer material such as Ta, Al or NiTa may be formed to have a thickness of several nanometers to suppress the diffusion. Thus, a perpendicular magnetic film can be obtained.

<Processing of Underlayer>

The underlayer can be processed by various methods.

For example, when fine particles having a diameter of several nanometers to several tens of nanometers are uniformly arranged on a substrate, an underlayer with projections and recesses can be prepared. When fine particles having a small dispersion of grain diameters are used, the dispersion of the grain diameters of the base lying layer can be suppressed as well. A self-assembled material such as a diblock copolymer, alumina nano-hole or meso-porous material or the like may be employed for a similar effect.

When an anode oxide alumina is used for a template, a thin film of Al is deposited in advance on a substrate to form an electrode, and then the electrode is exposed to an electric field in an acidic solution. In this manner, regularly arranged nanoholes can be obtained.

The mesoporous material will now be explained with reference to mesoporous silica as an actual example thereof.

TEOS (Tetraethoxysilane), a triblock copolymer, HCl, ethanol and water are mixed together, and the mixture is diluted to such a concentration as to make a single layer arrangement. Thus, the mixture is applied on the substrate by the spin coat method to form a single layer thereon. When the block copolymer is removed by baking, a regular pattern with pores having a several nanometers in size can be formed. In each of both cases, the planer image has a pattern similar to that of FIG. 2 except that the projections and recesses are reversed with each other and the portion denoted by reference numeral 3 forms a recess, as in the case of fine particle, diblock copolymer and the like. When the recesses are filled with a metal material by electrocasting or sputtering, thereby making it possible to reverse the projection and recess portions one another by etching process.

Alternatively, a eutectic crystal structure of AlSi or AgGe can be applied as well. Since a eutectic structure as it is has no projections or recesses, it is necessary to make projections and recesses by an etching process.

It is also possible to prepare an underlayer by applying one of the listed materials on a substrate on which an underlayer material such as carbon (C) was deposited, and making projections and recesses in the surface by an etching process such as RIE. In the case of a pattern transferring on a substrate, the hardness and adhesiveness are even more excellent as compared to the cases where fine particles or organic material are used directly for the underlayer.

For the patterning of the underlayer, various types of dry etching processes may be used as needed. For example, when using C, an etching with O₂ plasma can be used. In the case of Si, Ge, Ti, Fe, Co, Cr, Ta, W or Mo, an etching using a halogen gas such as CF₄, CF₄/O₂, CHF₃, SF₆ and Cl₂ can be used. In the case of noble metals which are difficult to be etched with O₂ or halogen, a technique of ion milling using a noble gas, or the like may be used. In the case where a halogen gas process is used, it is necessary to wash the resultant sufficiently with water after the process.

For the patterning of the underlayer, not only a dry-etching, but also a wet etching can be used. When a wet etching is used, it is possible to process a great number of substrates at once, thus improving the productivity. For example, for removing the Si or Ge boundary of the eutectic crystal structure, a hydrofluoric acid or alkali-etching liquid can be used.

<Fine Particles>

The size of fine particles used in the process of the underlayer can be set to about 1 nm to several tens of μm in grain diameter. The shapes of the grains are spherical in many cases, but other than that, there are, for example, tetrahedral, rectangular parallelepiped, octahedral, trigonal columnar, hexagonal columnar and cylindrical. In consideration of a regular arrangement, the symmetry in shape may be increased. In order to improve the arrangement properties during the application, the dispersion in grain diameter may be set smaller. For example, when used in an HDD medium, the dispersion in grain diameter may be set to 20% or less, or even 15% or less. When the dispersion in grain diameter is small, the jitter noise of the HDD medium can be reduced. When the dispersion exceeds 20%, the jitter noise is increased, and therefore, the S/N ratio of the medium tends to lower.

Examples of the material of the fine particles are metals, or inorganic substances and compounds thereof. More specifically, Al, Si, Ti, V, Cr, Mn, Fe, Co, Ni, Zn, Y, Zr, Sn, Mo, Ta, W and the like can be used. Further, oxides, nitrides, borides, carbides, sulfides thereof, etc. can be used. The fine particles may be either crystalline or amorphous. For example, the grains may be of a core-shell type structure, in which, for example, Fe is surrounded by FeOₓ (x=1 to 1.5). The core-shell type structure may be formed of materials of different compositions, in which, for example, Fe₃O₄ is surrounded by SiO₂. Further, such a structure may be taken that a metal core-shell type structure such as of Co/Fe is oxidized in its surface to make a three or more layered structure such as of Co/Fe/FeOₓ. When the main components are those of the above-listed, compounds with noble metals such as Pt and Ag may be used, for example, Fe₅₀Pt₅₀. But note that when the ratio of the noble metal exceeds 50%, a protective group is hard to bond, and therefore such a case is not appropriate.

The arrangement of fine particles is carried out in a solution system, and thus the fine particles are used in such a state that they are stably dispersed in the solution with protective groups attached thereof. To be applied on a substrate, the boiling point of the solvent may be set to 200° C. or less, or even 160° C. or less. Examples thereof are aromatic carbohydrates, alcohols, esters, ethers, ketones, glycol ethers, cyclic carbohydrates, aliphatic carbohydrates and the like. From the viewpoints of the boiling point and application properties, more specific usable examples are hexane, toluene, xylene, cyclohexane, cyclohexanone, propyleneglycolmonomethyletheracetate (PGMEA), diglyme, ethyl lactate, methyl lactate and tetrahydrofuran (THF). The fine particles are applied on the substrate to form a single layer while being dispersed in the above-described solvent by spin coat, dip coat, Langmuir-Blodgett method or the like.

<Eutectic Crystal>

The eutectic structure is formed by deposition or sputtering of two or more types of elements. Representative examples thereof are eutectic structures of Al—Ge and Ag—Ge. For example, with use of an Ag—Ge structure in which Ag is arranged in a cylindrical manner, a target projection and recess structure can be obtained. In this case, the composition ratio of the target may be set to about Ag₂₀Ge₈₀ to Ag₅₀Ge₅₀. When Ag—Ge is dipped in hydrofluoric acid having a concentration of 10% for several minutes, Ge can be dissolved to selectively keep Ag.

<Embedding Step>

For the media of the embodiment, a flattening process of embedding may be added. For embedding, a sputtering method which uses the embedding material as a target can be used since it is simple and easy. In addition, such a method as plating, ion beam deposition, chemical vapor deposition (CVD) or atomic layer deposition (ALD) may be used. With employment of CVD or ALD, it is possible to form a film at a high rate on a side wall of a highly tapered magnetic recording layer. Further, when applying a bias on the substrate while forming the layer by embedding, even high-aspect patterns can be embedded without making gaps. Alternatively, a method of spin-coating the so-called resist, including as Spin-On-Glass (SOG) or Spin-On-Carbon (SOC), and curing the resist by thermal treatment may be employed.

For the embedding material, SiO₂ can be used, but the material is not limited to this. That is, as long as the hardness and flatness are satisfied, any material can be used. For example, amorphous metals such as NiTa and NiNbTi are easily flattened and therefore can be used as the embedding material. When materials comprising C as the main component, such as CNₓ and CHₓ, are employed, a high hardness and a high adhesiveness with DLC can be achieved. Oxides and nitrides, such as SiO₂, SiNₓ, TiOₓ and TaOₓ, as well can be used as the embedding material. In the above-listed compounds, a range of 0<x≦3 needs to be satisfied. But, in the case where a magnetic recording layer and a reaction product are formed when contacting to the magnetic recording layer, a protective layer may be interposed between the embedding layer and the magnetic recording layer. Examples of such a protective layer are non-oxides such as Si, ti and Ta.

<Formation of Protective Layer and Post-Process>

The carbon protective layer may be formed by the CVD method in order to improve the coverage for the projections and recesses. Alternatively, the sputtering method or the vacuum deposition method may be used to form the layer. With the CVD method, a DLC film containing a great amount of sp³ bonding carbon is formed. When the thickness of the film is 2 nm or less, the coverage tends to be poor, whereas when it is 10 nm or more, the magnetic spacing between the recording/reproduction head and the medium is increased, and thus the SNR tends to lower. A lubricant may be applied on the protective layer. Usable examples of the lubricant are perfluoropolyether, alcohol fluoride and fluorinated carboxylic acid.

<Soft Magnetic Under Layer>

The soft magnetic under layer (SUL) serves part of the function of the magnetic head, that is, the recording magnetic field from the magnetic monopolar head configured to magnetize the perpendicular magnetic recording layer is allowed to pass in the horizontal direction to flow back towards the magnetic head (reflux). Thus, the SUL serves to apply a steep and sufficient perpendicular magnetic field onto a recording layer, thereby making it possible to enhance the recording/reproduction efficiency.

For the soft magnetic under layer, a material containing Fe, Ni or Co may be used. Examples of such a material are FeCo-based alloys such as FeCo and FeCoV, FeNi-based alloys such as FeNi, FeNiMo, FeNiCr and FeNiSi, FeAl-based alloys, FeSi-based alloys such as FeAl, FeAlSi, FeAlSiCr, FeAlSiTiRu and FeAlO, FeTa-based alloys such as FeTa, FeTaC and FeTaN, and FeZr-based alloy such as FeZrN. Materials with fine crystalline structures of FeAlO, FeMgO, FeTaN and FeZrN, which contain Fe in the amount of 60 at % or more, or with granular structures in which fine crystalline grains are dispersed in matrixes, can be employed as well.

As other materials for the soft magnetic under layer, a Co-alloy which contains Co and at least one type of Zr, Hf, Nb, Ta, Ti and Y can be used. The Co alloy can contain 80 at % or more of Co. When such a Co alloy is used to form a film by the sputtering method, an amorphous layer can be easily formed. The amorphous soft magnetic material does not have a crystal magnetic anisotropy, crystal defect or grain boundary, and it exhibits highly excellent soft magnetism. With the amorphous soft magnetic material, the noise of the media can be reduced. Examples of the amorphous soft magnetic material are CoZr-, CoZrNb- and CoZrTa-based alloys.

Under the soft magnetic under layer, an underlying layer may be further provided to improve the crystallinity of the soft magnetic under layer or the adherence to the substrate. Examples of the material for such an underlying layer are Ti, Ta, W, Cr and Pt, alloys containing any of these, oxides thereof and nitrides thereof.

In order to prevent spike noise, the soft magnetic under layer may be divided into a plurality of layers, and Ru layers of 0.5 to 1.5 nm may be inserted therebetween. In this manner, these layers can be antiferromagnetically coupled with one another.

Further, a pin layer comprising a hard magnetic film having an in-plane anisotropy, such as of CoCrPt, SmCo and FePt, or an antiferromagnetic material of IrMn or PtMn, can be coupled with the soft magnetic layer. In order to control the exchange coupling force, a magnetic film (of, for example, Co) or a non-magnetic film (of, for example, Pt) may be stacked on upper and lower sides of each of the Ru layers.

### Example 1

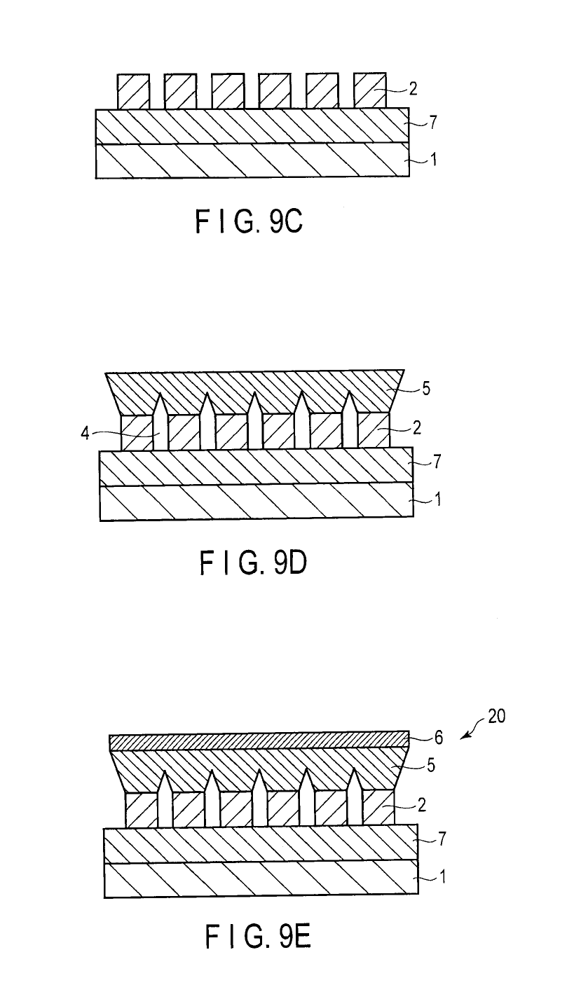

An example of a manufacturing process of a magnetic recording medium according to the embodiments is shown in FIGS. 9A to 9E.

First, as shown in FIG. 9A, a soft magnetic under layer 7 of CoZrNb was formed to have a thickness of 50 nm on a glass substrate 1, and a carbon-made underlayer 2 to be processed was formed to have a thickness of 20 nm thereon. On top of that, a PGMEA solvent in which acryl monomers and FeOₓ fine particles 8 having a diameter of 7 nm are dispersed, was applied such that the FeOₓ fine particles 8 form a single layer. Thus, an FeOₓ fine particle coating layer 11 which contains the FeOₓ fine particles 8 and an acryl resin layer 9 formed to surround the particles, was obtained. To the fine particles 8, polystyrene having a molecular weight of 1,000 is attached as a protecting group, and are arranged on the substrate 1 at a pitch of 10 nm. After the arrangement, such a hexagonal close-packed pattern as shown in FIG. 2 was obtained.

Next, as shown in FIG. 9B, the C-made underlayer 2 was etched together with the acryl resin layer 9 formed around the fine particles 8 by dry etching using the FeOₓ fine particles 8 as a mask, and thus the C-made underlayer 2 comprising projecting portions was formed on the substrate 1. This process was carried out with an inductively coupled plasma (ICP) RIE device using O₂ gas as a process gas, at a chamber pressure of 0.1 Pa, a coil RF power of 40 W and a platen RF power of 40 W for an etching time of 40 seconds, as an example. With this process, the C-made underlayer 2 was etched to form projecting portions of the C-made underlayer 2, having a height of 15 nm, on the substrate 1 and the soft magnetic under layer 7.

Next, as shown in FIG. 9C, the FeOₓ fine particles 8 were removed from above the substrate 1. Here, the substrate 1 was dipped in hydrochloric acid of a concentration of 1 wt % for 10 minutes to dissolve the FeOₓ fine particles 8 into hydrochloric acid to be removed from above the substrate 1. Then, the substrate 1 was washed with pure water to prevent corrosion caused by hydrochloric acid if remains.

As shown in FIG. 9D, an amorphous recording layer was deposited on the C-made underlayer 2 on the substrate 1 by sputtering process performed at pressure of 3 Pa under Ar atmosphere. Here, first, a buffer layer of Ta, which is not shown in the figure, was deposited to have a thickness of 2 nm, and thereafter, a Tb₁₅Co₈₁Cr₄ amorphous recording layer 5 was deposited to have a thickness of 20 nm.

Then, as shown in FIG. 9E, a C-made protective film 6 was deposited to have a thickness of 4 nm on the recording layer 5 by chemical vapor deposition (CVD), and a lubricant, not shown, was applied, thus obtaining a target magnetic recording medium 20.

The thus obtained magnetic recording medium was evaluated with a Kerr effect measuring device.

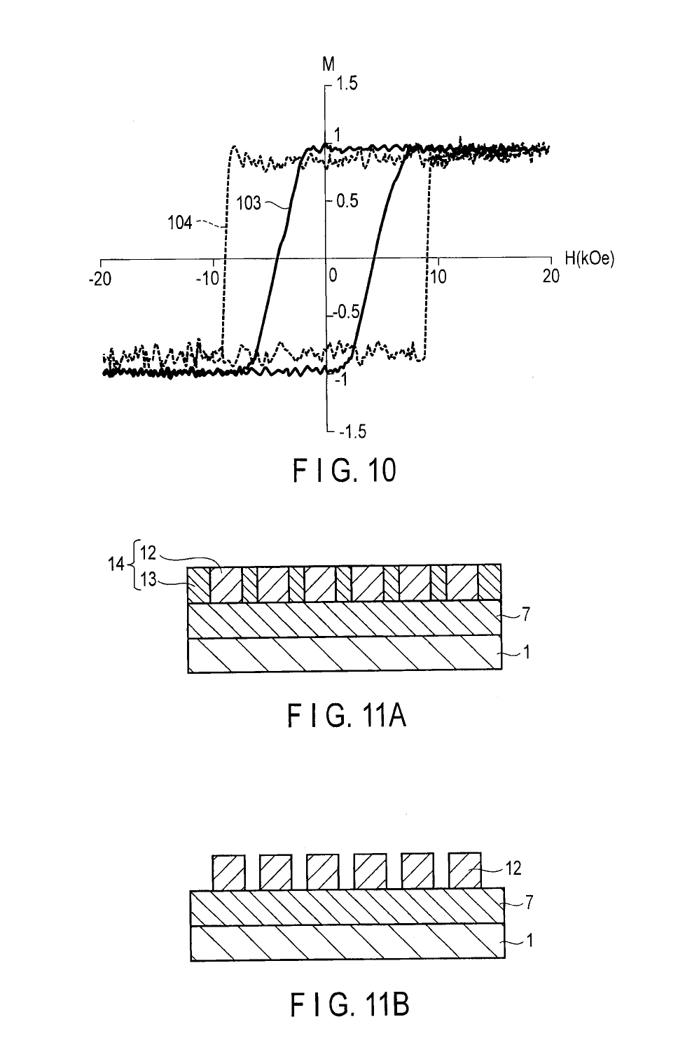

FIG. 10 is a graph showing magnetization curves obtained by the measurements with the Kerr effect measuring device.

In this figure, a magnetization curve 103 indicates the results of Example 1.

As shown, it was confirmed that the squareness was 1, Hc was 4 kOe, Hn=2 kOe and Hs=8 kOe. Further, the slope α of the loop near the coercive force Hc was 1.9. From the magnetization curve, it is estimated that the reversal mode was not of a domain wall motion type, but of a type in which magnetic grains magnetically isolated rotate by magnetization. The magnetic recording medium was set on a spin stand, and a writing was carried out at a recording density of 500 kFCI. Here, a clear reproduction waveform was confirmed.

### Comparative Example 1

A magnetic recording medium was manufactured by a method similar to that of Example 1 except that an Al layer having a thickness of 2 nm was formed in place of applying the FeOₓ fine particles 8. The roughness of the Al layer was 3 nm in Rmax and 0.36 nm in Ra, where Rmax is the maximum value of differences between top and bottom in the projections and recesses when the surface roughness was measured using an atomic force microscope (AFM) for an area of 10 μm square, and Ra represents the average of absolute values of the differences between top and bottom.

Here, a Tb₁₅Co₈₁Cr₄ layer was deposited to have a thickness of 20 nm on the Al layer, and a C protective film was deposited as in Example 1. The thus obtained magnetic recording medium was evaluated with a Kerr effect measuring device in a similar manner to that of Example 1. A magnetization curve obtained by the measurements with the Kerr effect measuring device is also indicated in FIG. 10.

In this figure, a magnetization curve 104 indicates the results of Comparative Example 1.

As shown, it was confirmed that the squareness was 1 and Hc was 4 kOe as in Example 1. On the other hand, the slope of the Kerr loop in Hc was very large, and thus it was found that the reversal mode was of a domain wall motion type.

The magnetic recording medium was set on a spin stand, and a writing was carried out at a recording density of 500 kFCI. Here, no reproduction waveform was confirmed. This is considered because the surface roughness of the Al layer results in a poor force to pin the domain walls, which disabled the recording. From the results thus obtained, it was confirmed that the medium manufactured by the method according to the embodiment have a sufficient performance as a magnetic recording medium.

### Example 2

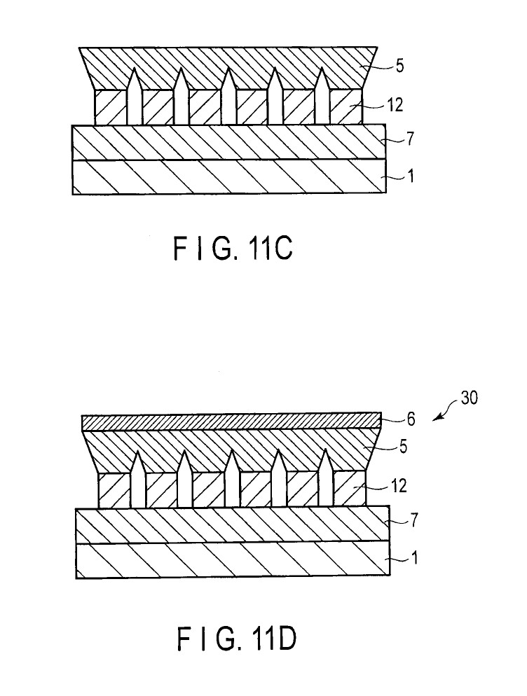

Another example of the manufacturing process of a magnetic recording medium according to the embodiments is shown in FIGS. 11A to 11E.

First, as shown in FIG. 11A, a soft magnetic under layer 7 of CoZrNb having a thickness of 50 nm and an underlayer of Ag₃₀Ge₇₀ to be processed, having a thickness of 10 nm were formed to on a glass substrate 1. The AgGe underlayer 14 to be processed had a eutectic crystal structure, in which Ag grains 12 were arranged in a Ge grain boundary 13 at a pitch of 8 nm.

Next, as shown in FIG. 11B, the Ge grain boundary 13 was removed by wet etching using hydrofluoric acid, and thus, projecting portions of the Ag grains 12 were formed. Here, Ge was removed as dipped in hydrofluoric acid of a concentration of 1% for 1 minute, and the projecting portions having a height of 10 nm were formed on the substrate 1.

Then, as shown in FIG. 11C, an amorphous recording layer was deposited on the substrate 1. Here, first, a buffer layer of Al, which is not shown in the figure, was deposited to have a thickness of 2 nm, and thereafter, a Tb₂₄Fe₅₂Co₂₄ layer 5 was deposited to have a thickness of 15 nm by sputtering process performed at pressure of 3 Pa under Ar atmosphere.

Then, as shown in FIG. 11D, a C-made protective film 6 was deposited to have a thickness of 4 nm on the recording layer by chemical vapor deposition (CVD), and a lubricant, not shown, was applied, thus obtaining a target magnetic recording medium 30.

The thus obtained magnetic recording medium was evaluated with a Kerr effect measuring device. Here, it was confirmed that the squareness was 1 and Hc was 3 kOe. Further, the slope α of the loop was 2.5. The magnetic recording medium was set on a spin stand, and a writing was carried out at a recording density of 500 kFCI. Here, a clear reproduction waveform was confirmed.

### Examples 3-1, 3-2 and 3-3

Patterned media having amorphous recording layers were manufactured by a method similar to that of Example 1 except that the conditions for the RIE process for the underlayer were varied to manufacture those having groove widths of 5 nm, 2 nm, 1 nm and 0.5 nm, that is, the distance between adjacent projections.

Here, the media were subjected to AC demagnetization, and then measured in terms of minor loops, thereby obtaining the magnetic domain size for each.

It should be noted that the magnetic domain size measurement is a technique of estimating a magnetic reversal volume from a minor loop. The magnetic domain size is about 20 to 30 nm for a granular medium having a grain diameter of 9 nm. Here, in practice, the domain size cannot be that of one magnetic grain in many cases, and therefore it is important that this numerical value is as close as possible to those obtained with the granular media. The results indicated that the M-H loop had a slope in the cases up to that the groove width was 1 nm, but the domain size was not measurable for the case where the groove width was 0.5 nm. This is because with a groove width of 0.5 nm, the magnetic characteristics where shifted to those of the magnetic domain wall motion type.

Further, the media were measured in terms of cross sectional TEM to examine how much in ratio the grains were separated with respect to the entire thickness of the film. Here, for the cases where the groove width was 1 nm or more, it was observed that the grains were separated along the underlayer, whereas in the case of the groove width of 0.5 nm, the grains grew in the form of a flat film.

TABLE 1

| | Groove | | | Thickness of | |
|---|---|---|---|---|---|
| | width | | Domain size | film separated | Evaluation |
| Example 3-1 | 5 | nm | 25 nm | 100% | ⊚ |
| Example 3-2 | 2 | nm | 28 nm | 50 to 70% | ⊚ |
| Example 3-3 | 1 | nm | 36 nm | 30% | ◯ |
| Comparative | 0.5 | nm | Immesurable | Not divided | X |
| Example 3-1 | | | | | |

From the results obtained, it was found that magnetic recording media having appropriate values in domain size can be obtained when the groove width is 1 nm or more and the thickness of the film separated is 30% or more of the entire thickness.

### Examples 4-1, 4-2, 4-3 and 4-4

Patterned media having amorphous recording layers were manufactured by a method similar to that of Example 1 except that the conditions for the RIE process for the underlayer were varied to manufacture those having shapes of semicircular, trapezoidal, cylindrical and V-shaped groove as indicated in Examples 4-1 to 4-4 of Table 2 below. The media were subjected to cross sectional TEM to measure groove width and groove depth, and the results were as indicated in Table 2. It was determined as to whether or not the separation of grains sufficiently progressed based on the measurement of the slope α of the magnetization curve with VSM. If α≧5, it was evaluated as no good (X), if 5>α>3, it was evaluated as not good enough (Δ), and if 3≧α, it was evaluated as good (◯). In all of the samples, the separation of grains was observed in the underlayer.

TABLE 2

| | | Groove width | | Groove | | Separation |
|---|---|---|---|---|---|---|
| | Shape | of top portion | | depth | | of grains |
| Example 4-1 | Semicircular | 10 | nm | 3 | nm | ◯ |
| Example 4-2 | Trapezoidal | 5 | nm | 8 | nm | ◯ |
| Example 4-3 | Cylindrical | 2 | nm | 10 | nm | ◯ |
| Example 4-4 | V-shaped groove | 8 | nm | 20 | nm | ◯ |

From the results obtained, it was found that target amorphous recording layers can be obtained by using the underlayers of Example 4.

### Examples 5-1, 5-2, 5-3, 5-4, 5-5, 5-6, 5-7, 5-8 and 5-9

Patterned media having amorphous recording layers were manufactured by a method similar to that of Example 1 except that the material of the amorphous recording layer was varied to compositions as indicated in Table 3 below. It was determined as to whether or not the separation of grains sufficiently progressed based on the measurement of the slope with VSM. If α≧5, it was evaluated as no good (X), if 5>α>3, it was evaluated as not good enough (A), and if 3≧α, it was evaluated as good (◯).

TABLE 3

| | Composition of | | Separation |
|---|---|---|---|
| | recording layer | Film thickness | of grains |
| Example 1 | Tb₁₅Co₈₁Cr₄ | 20 nm | ◯ |
| Example 5-1 | Tb₁₅Co₈₅ | 25 nm | ◯ |
| Example 5-2 | Tb₁₁Fe₂₅Co₆₄ | 20 nm | ◯ |
| Example 5-3 | Tb₁₁Fe₂₅Co₆₁Cr₃ | 20 nm | ◯ |
| Example 5-4 | Tb₂₉Fe₆₇Al₄ | 15 nm | ◯ |
| Example 5-5 | Tb₂₉Fe59Co7Pt₅ | 20 nm | ◯ |
| Example 5-6 | Tb₂₉Fe₅₉Co₇Ag₅ | 20 nm | ◯ |
| Example 5-7 | Tb₂₉Fe₅₉Co₇Au₅ | 20 nm | ◯ |
| Example 5-8 | Tb₁₁Ti₂₅Co₆₄ | 20 nm | ◯ |
| Example 5-9 | Tb₁₁Si₂₅Co₆₄ | 20 nm | ◯ |

The results indicated that media with desired separation of grains were obtained even in the cases where various materials were added to the respective amorphous recording layers.

### Examples 6-1, 6-2 and 6-3

Amorphous recording layers of the embodiments were deposited on various underlayers, and they were examined in terms of a. The results were as shown in Table 4. The amorphous recording layers were of Tb₁₅Co₈₁Cr₄ having a thickness of 20 nm and deposited on Ta buffer layers having a thickness of 2 nm, respectively. The protective layer was CN and had a thickness of 6 nm.

In Examples 6-1 and 6-2, the C underlayer was etched with a template of Fe grains having a diameter of 8 nm to remove the grains. The difference between the top and bottom of the projection-and-recesse portions was 5 nm in Example 6-1 and it was 10 nm in Example 6-2. In Example 6-3, AlSi eutectic crystals were deposited to have a thickness of 10 nm by sputtering, and only Si was removed by wet etching while keeping Al. In Example 6-4, Au fine particles were applied on a substrate to form a single layer, and an amorphous recording layer was deposited thereon. As comparative examples, samples were prepared, in which the underlayers were not processed, and Ta and Au were deposited respectively to have a thickness of 2 nm. The difference between the top and bottom was 1.5 nm in one sample, and was 2 nm in the other at Rmax.

All of the media obtained above were measured in terms of M-H loop with a Kerr effect measuring device to calculate out the slope α. Those with processed underlayers exhibited small values of a, which were all less than 5. The results indicate characteristics of the magnetization rotary type. By contrast, the cases of the back layers without being processed all showed a values of 5 or higher, which indicated characteristics of the magnetic domain wall motion type.

TABLE 4

| | | Processed | Difference between | | |
|---|---|---|---|---|---|
| | Underlying | underlying | top and bottom in | | |
| | template | layer | projection and recess | | α |
| Example 6-1 | Fe grains | C | 5 | nm | 1.4 |
| Example 6-2 | Fe grains | C | 10 | nm | 1.4 |
| Example 6-3 | AlSi eutectic | Al | 10 | nm | 1.2 |
| | crystal | | | | |
| Example 6-4 | Au grains | Absent | 8 | nm | 2.0 |
| Comparative | Absent | Ta(2 nm) | 1.5 | nm | 125 |
| Example 6-1 | | | | | |
| Comparative | Absent | Au(2 nm) | 2 | nm | 18 |
| Example 6-2 | | | | | |

### Example 7

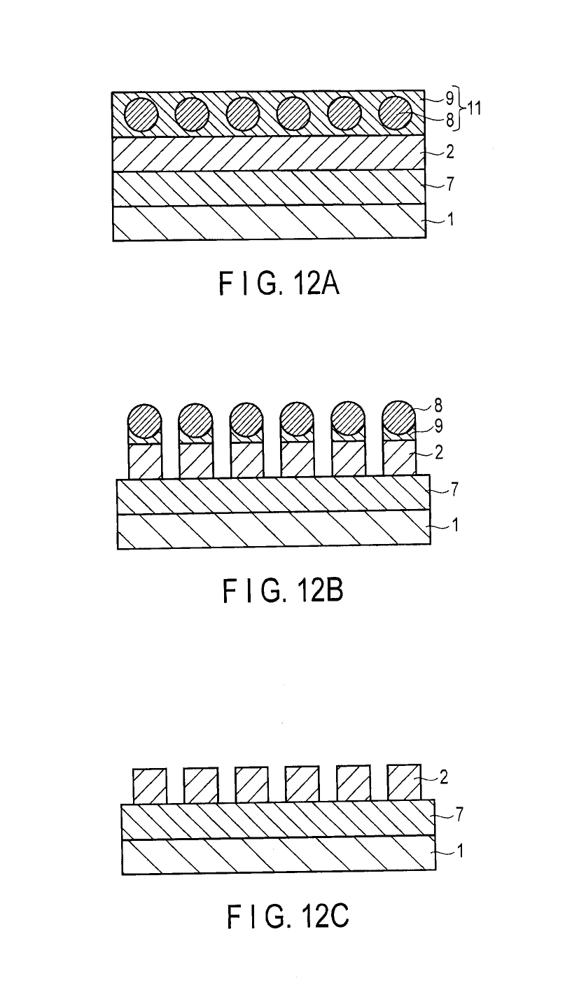

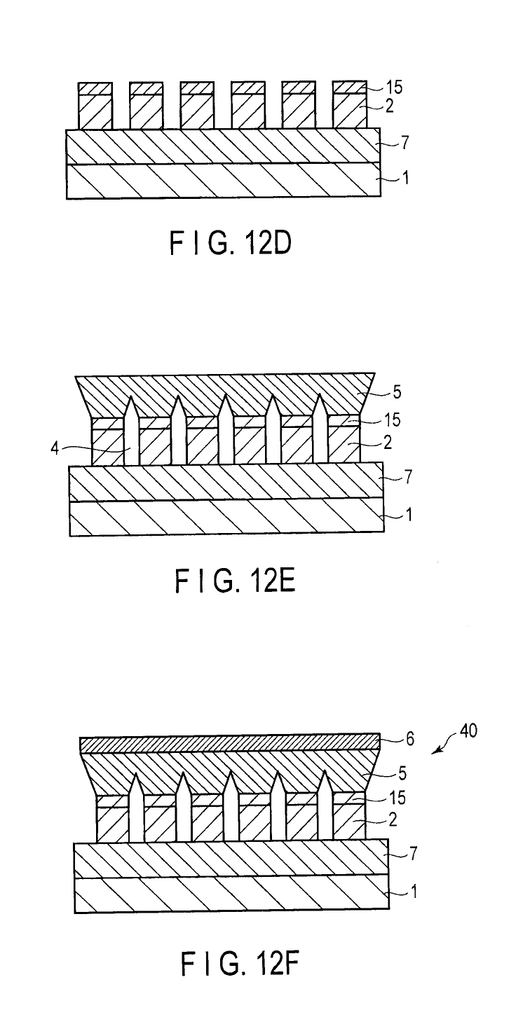

FIGS. 12A to 12F show still another example of the method of manufacturing a magnetic recording medium, according to an embodiment.

First, as shown in FIG. 12A, a soft magnetic under layer 7 made of CoZrNb and having a thickness of 50 nm, and a to-be-processed underlayer 2 made of C and having a thickness of 20 nm, were formed on a glass substrate 1. On top of that, a PGMEA solvent in which acryl monomer and FeOₓ fine particles 8 having a diameter of 7 nm were dispersed was applied such that the FeOₓ fine particles 8 formed a single layer. Thus, an FeOₓ fine particle coating layer 11 was obtained, which contained the FeOₓ fine particles 8 and an acryl resin layer 9 formed around the particles. To each of the fine particles 8, polystyrene having a molecular weight of 1,000 attached as a protective group, and the particles were arranged on the substrate 1 at a pitch of 10 nm. After the arrangement, a hexagonal close-packed structure as shown in FIG. 2 was obtained.

As shown in FIG. 12B, dry-etching was carried out, in which the C underlayer 2 was etched together with the acryl resin layer 9 formed around the fine particles 8 using the FeOₓ fine particles 8 as a mask, and thus the C underlayer 2 shaped into projecting portions was formed on the substrate 1. This process was carried out with, for example, an ICP-RIE device, using O₂ gas as a process gas, at a chamber pressure of 0.1 Pa, a coil RF power of 40 W, a platen RF power of 40 W, and an etching time of 40 seconds. With this process, the C underlayer 2 was etched into projecting portions formed on the substrate 1 and the soft magnetic layer 7 to have a height of 15 nm.

Next, as shown in FIG. 12C, the FeOₓ fine particles 8 were removed from the substrate 1. More specifically, the substrate 1 was immersed in a hydrochloric acid solution having a concentration of 1% by weight for 10 minutes, and thus the FeOₓ fine particles 8 were dissolved with the hydrochloric acid and removed. The substrate 1 was washed with pure water to prevent corrosion due to remaining hydrochloric acid.

Then, as shown in FIG. 12D, amorphous Ni₅₀Ta₅₀ (to be referred to as NiTa hereinafter) was deposited to have a thickness of 10 nm as an anti-oxidation layer 15 for the underlayer with projecting and recessed portions, on the C-underlayer 2. The anti-oxidation layer 15 was deposited while tracing the shape of the projections and recesses of the C-underlayer 2 without filling the gaps between the projecting and recessed portions.

Next, as shown in FIG. 12E, an amorphous recording layer was deposited on the anti-oxidation layer 15 on the C-underlayer 2. After that, a Tb₁₅Co₈₁Cr₄ amorphous recording layer 5 was deposited to have a thickness of 20 nm by sputtering process performed at pressure of 3 Pa under Ar atmosphere.

Then, as shown in FIG. 12F, a C-protective film 6 was deposited by chemical vapor deposition (CVD) to have a thickness of 4 nm on the recording layer 5, and a lubricant not shown was applied thereon. Thus, a target magnetic recording medium 40 was obtained.

The thus obtained magnetic recording medium was evaluated with a Kerr effect measuring device, and it was confirmed that the squareness was 1, Hc was 9 kOe, and the slope α of the loop near the coercive force Hc was 2.5. From the magnetization curve, it was estimated that the reversal mode was not of a domain wall motion type, but of a type in which magnetically isolated magnetic grains rotate by magnetization. The magnetic recording medium was set on a spin stand, and a writing was carried out at a recording density of 500 kFCI. Here, a clear reproduction waveform was confirmed.

### Examples 8-1, 8-2, 8-3, 8-4, 8-5, 8-6, 8-7, 8-8 and 8-9

Magnetic recording media were manufactured by a method similar to that of Example 7 except that as an anti-oxidation layer in addition to NiTa (Example 7), the following materials were respectively used: Zr₅₀Mo₅₀ (Example 8-1), Ti₇₅Cu₂₅ (Example 8-2), Hf₆₀Ni₄₀ (Example 8-3), Nb₄₀Ir₆₀ (Example 8-4), Zr₂₅Rh₇₅ (Example 8-5), Pd₂₅Zr₇₅ (Example 8-6), Fe₃₀Zr₇₀ (Example 8-7), Co₃₀Zr₇₀ (Example 8-8) and Cr₅₀Ti₅₀ (Example 8-9).

For each sample, a writing was carried out at a recording density of 500 kFCI and the SNR of the waveform was measured using the same recording/reproduction head. The results are shown in Table 5. The evaluation results were obtained based on the following criteria. That is, if the SNR was no less than 17 dB, it was evaluated as very good (⊚); if no less than 10 dB, it was evaluated as good (◯); if no less than 5 dB, it was evaluated as poor (Δ); and if less than 0 dB, and it was evaluated as unacceptable (X). Amorphous recording layers grown on the underlayers with projecting and recessed portions exhibited excellent signal-to-noise ratios, and in particular, those provided with an anti-oxidation layer of an amorphous material exhibited excellent characteristics.

TABLE 5

| | Thickness of Anti- | | |
|---|---|---|---|
| | oxidation layer | SNR | Evaluation |
| Example 1 | — | 9 dB | Δ |
| Example 7 | NiTa (10 nm) | 20 dB | ⊚ |
| Example 8-1 | ZrMo (10 nm) | 18 dB | ⊚ |
| Example 8-2 | TiCu (10 nm) | 19 dB | ⊚ |
| Example 8-3 | HfNi (10 nm) | 16 dB | ◯ |
| Example 8-4 | NiIr (10 nm) | 16 dB | ◯ |
| Example 8-5 | ZrRh (10 nm) | 15 dB | ◯ |
| Example 8-6 | PdZr (5 nm) | 15 dB | ◯ |
| Example 8-7 | FeZr (5 nm) | 11 dB | ◯ |
| Example 8-8 | CoZr (5 nm) | 12 dB | ◯ |
| Example 8-9 | CrTi (5 nm) | 17 dB | ⊚ |
| Comparative | — | −20 dB | X |
| Example 1 | | | |

### Examples 9-1, 9-2, 9-3, 9-4, 9-5, 9-6, 9-7 and 9-8

Magnetic recording media were manufactured by a method similar to that of Example 7 except that the thickness of the NiTa layer was changed to 0.5 nm (Example 9-1), 1 nm (Example 9-2), 2 nm (Example 9-3), 5 nm (Example 9-4), 10 nm (Example 9-5), 20 nm (Example 9-6), 30 nm (Example 9-7) and 50 nm (Example 9-8).

For each sample, a writing was carried out at a recording density of 500 kFCI and the SNR of the waveform was measured using the same recording/reproduction head. The results are shown in Table 6. The evaluation results were obtained based on the following criteria. That is, if the SNR was no less than 17 dB, it was evaluated as very good (⊚); if no less than 10 dB, it was evaluated as good (◯); if no less than 5 dB, it was evaluated as poor (Δ); and if less than 0 dB, and it was evaluated as unacceptable (X). Media provided with anti-oxidation layers of amorphous materials exhibited excellent signal-to-noise ratios, and in particular, those having a thickness of 1 to 30 nm in the anti-oxidation layer exhibited excellent characteristics.

TABLE 6

| | Thickness of Anti- | | |
|---|---|---|---|
| | oxidation layer | SNR | Evaluation |
| Example 1 | — | 9 dB | Δ |
| Example 9-1 | NiTa (0.5 nm) | 8 dB | Δ |
| Example 9-2 | NiTa (1 nm) | 10 dB | ◯ |
| Example 9-3 | NiTa (2 nm) | 13 dB | ◯ |
| Example 9-4 | NiTa (5 nm) | 19 dB | ⊚ |
| Example 9-5 | NiTa (10 nm) | 20 dB | ⊚ |
| Example 9-6 | NiTa (20 nm) | 13 dB | ◯ |
| Example 9-7 | NiTa (30 nm) | 11 dB | ◯ |
| Example 9-8 | NiTa (50 nm) | 2 dB | Δ |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A perpendicular magnetic recording medium comprising:
a substrate;
an underlayer formed on the substrate and comprising a plurality of projecting portions arranged at a distance of 1 nm to 20 nm from one another; and
an amorphous magnetic recording layer comprising a plurality of magnetic grains each formed to expand towards a top end thereof from a surface of a respective projecting portion of the underlayer, having an easy axis in a direction perpendicular to a film surface, at least those of the magnetic grains located on a respective projecting portion side being separated from each other.

2. The perpendicular magnetic recording medium of claim 1, wherein the top ends of the plurality of magnetic grains are brought into contact with each other, and those of the magnetic grains located on the respective projecting portion side are separated from each other in a film thickness direction by ⅓ or more.

3. The perpendicular magnetic recording medium of claim 1, wherein a dispersion of pitches of the projecting portions is 20% or less.

4. The perpendicular magnetic recording medium of claim 1, wherein the projecting portions have one of semicircular and trapezoidal shape in cross section.

5. The perpendicular magnetic recording medium of claim 1, wherein the amorphous magnetic recording layer comprises a rare earth element-transition metal alloy and the rare earth element is at least one type selected from the group consisting of samarium, gadolinium, terbium and dysprosium, and the transition metal alloy is at least one of iron and cobalt.

6. The perpendicular magnetic recording medium of claim 5, wherein the amorphous magnetic recording layer comprises a terbium-cobalt alloy.

7. The perpendicular magnetic recording medium of claim 5, wherein the amorphous magnetic recording layer further comprises at least one additive element selected from the group consisting of platinum, gold, silver, indium, chromium, titanium, silicon and aluminum.

8. The perpendicular magnetic recording medium of claim 7, wherein an amount of the additive element added is 30 at % or less.

9. The perpendicular magnetic recording medium of claim 1, wherein the underlayer comprising the plurality of projecting portions contains at least one type selected from the group consisting of carbon, silicon, aluminum, titanium, chromium, manganese, iron, cobalt, nickel, copper, zinc, germanium, zirconium, niobium, molybdenum, ruthenium, rhodium, palladium, silver, indium, hafnium, tantalum, tungsten, iridium, platinum, iron, alloys thereof and compounds thereof.

10. The perpendicular magnetic recording medium of claim 1, wherein the amorphous magnetic recording layer has a thickness of 3 nm to 30 nm.

11. The perpendicular magnetic recording medium of claim 1, wherein the plurality of projecting portions have a height of 3 nm to 30 nm.

12. The perpendicular magnetic recording medium of claim 1, wherein the plurality of projecting portions are arranged at a pitch of 4 nm to 20 nm.

13. The perpendicular magnetic recording medium of claim 1, further comprising an anti-oxidation layer between the underlayer comprising a plurality of projecting portions, and the amorphous magnetic recording layer.

14. The perpendicular magnetic recording medium of claim 13, wherein the anti-oxidation layer has an amorphous structure.

15. The perpendicular magnetic recording medium of claim 13, wherein the anti-oxidation layer contains at least one metal selected from the group consisting of titanium, tantalum, hafnium, niobium and zirconium, and at least one metal selected from the group consisting of chromium, iron, cobalt, nickel, copper, molybdenum, rhodium, palladium and iridium.

16. The perpendicular magnetic recording medium of claim 13, wherein the anti-oxidation layer has a thickness of 1 nm to 30 nm.

17. The perpendicular magnetic recording medium of claim 1, wherein a slope α of a magnetization curve near a coercive force Hc expressed by a following formula (1):
α=4πdM/dH|H=Hc (1),
is less than 5, where M represents a magnetization, H represents a magnetic field, and Hc represents a coercive force.

18. A method of manufacturing a perpendicular magnetic recording medium, the method comprising:
forming an underlayer to be processed on a substrate;
applying a dispersion liquid in which fine particles are dispersed, on the underlayer to be processed, thereby forming a single layer of the fine particles;
etching the underlayer to be processed, via the fine particles, thereby processing the underlayer to comprise projecting portions; and
depositing an amorphous magnetic recording layer on a surface of the underlayer comprising the projecting portions.

19. The manufacturing method of claim 18, wherein the amorphous magnetic recording layer can be deposited at pressure at least 0.5 Pa under inert atmosphere.

20. The manufacturing method of claim 18, wherein a dispersion of pitches of the projecting portions is 20% or less.

21. The manufacturing method of claim 18, wherein the projecting portions have one of semicircular and trapezoidal shape in cross section.

22. The manufacturing method of claim 18, wherein the amorphous magnetic recording layer comprises a rare earth element-transition metal alloy and an additive element, and the rare earth element is at least one type selected from the group consisting of samarium, gadolinium, terbium and dysprosium, and the transition metal alloy is at least one of iron and cobalt.

23. The manufacturing method of claim 22, wherein the amorphous magnetic recording layer comprises a terbium-cobalt alloy.

24. The manufacturing method of claim 22, wherein
the amorphous magnetic recording layer further comprises at least one additive element selected from the group consisting of platinum, gold, silver, indium, chromium, titanium, silicon and aluminum.

25. The manufacturing method of claim 24, wherein an amount of the additive element added is 30 at % or less.

26. The manufacturing method of claim 18, wherein the underlayer comprising the plurality of projecting portions contains at least one type selected from the group consisting of carbon, silicon, aluminum, titanium, chromium, manganese, iron, cobalt, nickel, copper, zinc, germanium, zirconium, niobium, molybdenum, ruthenium, rhodium, palladium, silver, indium, hafnium, tantalum, tungsten, iridium, platinum, iron, alloys thereof and compounds thereof.

27. The manufacturing method of claim 18, wherein the amorphous magnetic recording layer has a thickness of 3 nm to 30 nm.

28. The manufacturing method of claim 18, wherein the plurality of projecting portions have a height of 3 nm to 30 nm.

29. The manufacturing method of claim 18, wherein the plurality of projecting portions are arranged at a pitch of 4 nm to 20 nm.

30. The manufacturing method of claim 18, further comprising: forming an anti-oxidation layer on the underlayer comprising a plurality of projecting portions, before depositing the amorphous magnetic recording layer over the plurality of projecting portions.

31. The manufacturing method of claim 30, wherein the anti-oxidation layer has an amorphous structure.

32. The perpendicular magnetic recording medium of claim 30, wherein the anti-oxidation layer contains at least one metal selected from the group consisting of titanium, tantalum, hafnium, niobium and zirconium, and at least one metal selected from the group consisting of chromium, iron, cobalt, nickel, copper, molybdenum, rhodium, palladium and iridium.

33. The perpendicular magnetic recording medium of claim 30, wherein the anti-oxidation layer has a thickness of 1 nm to 30 nm.

34. The manufacturing method of claim 18, wherein a slope α of a magnetization curve near a coercive force Hc expressed by a following formula (1):
α=4πdM/dH|H=Hc (1),
is less than 5, where M represents a magnetization, H represents a magnetic field, and Hc represents a coercive force.

35. A method of manufacturing a perpendicular magnetic recording medium, the method comprising:
forming a substrate on an underlayer to be processed, using a metal compound having a eutectic crystalline structure of grains and a grain boundary;
etching the underlayer to be processed, such that the grains of the eutectic crystalline structure remain to process the underlayer to comprise projecting portions; and
depositing an amorphous magnetic recording layer on a surface of the underlayer comprising the projecting portions.

36. The manufacturing method of claim 35, wherein the amorphous magnetic recording layer can be deposited at pressure at least 0.5 Pa under inert atmosphere.

37. The manufacturing method of claim 35, wherein a dispersion of pitches of the projecting portions is 20% or less.

38. The manufacturing method of claim 35, wherein the projecting portions have one of semicircular and trapezoidal shape in cross section.

39. The manufacturing method of claim 35, wherein the amorphous magnetic recording layer comprises a rare earth element-transition metal alloy and an additive element, and the rare earth element is at least one type selected from the group consisting of samarium, gadolinium, terbium and dysprosium, and the transition metal alloy is at least one of iron and cobalt.

40. The manufacturing method of claim 39, wherein the amorphous magnetic recording layer comprises a terbium-cobalt alloy.

41. The manufacturing method of claim 39, wherein
the amorphous magnetic recording layer further comprises at least one additive element selected from the group consisting of platinum, gold, silver, indium, chromium, titanium, silicon and aluminum.

42. The manufacturing method of claim 40, wherein an amount of the additive element added is 30 at % or less.

43. The manufacturing method of claim 35, wherein the underlayer comprising the plurality of projecting portions contains at least one type selected from the group consisting of carbon, silicon, aluminum, titanium, chromium, manganese, iron, cobalt, nickel, copper, zinc, germanium, zirconium, niobium, molybdenum, ruthenium, rhodium, palladium, silver, indium, hafnium, tantalum, tungsten, iridium, platinum, iron, alloys thereof and compounds thereof.

44. The manufacturing method of claim 35, wherein the amorphous magnetic recording layer has a thickness of 3 nm to 30 nm.

45. The manufacturing method of claim 35, wherein the plurality of projecting portions have a height of 3 nm to 30 nm.

46. The manufacturing method of claim 35, wherein the plurality of projecting portions are arranged at a pitch of 4 nm to 20 nm.

47. The manufacturing method of claim 35, further comprising: forming an anti-oxidation layer on the underlayer comprising a plurality of projecting portions, before depositing the amorphous magnetic recording layer over the plurality of projecting portions.

48. The manufacturing method of claim 47, wherein the anti-oxidation layer has an amorphous structure.

49. The perpendicular magnetic recording medium of claim 47, wherein the anti-oxidation layer contains at least one metal selected from the group consisting of titanium, tantalum, hafnium, niobium and zirconium, and at least one metal selected from the group consisting of chromium, iron, cobalt, nickel, copper, molybdenum, rhodium, palladium and iridium.

50. The perpendicular magnetic recording medium of claim 47, wherein the anti-oxidation layer has a thickness of 1 nm to 30 nm.

51. The manufacturing method of claim 35, wherein a slope α of a magnetization curve near a coercive force Hc expressed by a following formula (1):
α=4πdM/dH|H=Hc (1),
is less than 5, where M represents a magnetization, H represents a magnetic field, and Hc represents a coercive force.
